(19) United States
(12) Patent Application Publication
(10) Pub. No.: US 2013/0025193 A1
(43) Pub. Date: Jan. 31, 2013

(54) Convex Cutting and Trimming Method to Re-orient New Growth for Shaping Trees

(71) Applicant: Robert J. N. Stafford, Alexandria, IN (US)

(72) Inventor: Robert J. N. Stafford, Alexandria, IN (US)

(21) Appl. No.: 13/633,426

(22) Filed: Oct. 2, 2012

Related U.S. Application Data
(63) Continuation-in-part of application No. 12/859,237, filed on Aug. 18, 2010, now abandoned.
(60) Provisional application No. 61/235,026, filed on Aug. 19, 2009.

(51) Int. Cl. A01G 3/00; A01G 3/08

(52) U.S. Cl. 47/8; 144/343

(57) ABSTRACT

A tree trimming method that is related to a convex method of pre-determined angular trimming of deciduous trees. The methodology uses pre-determined angle cuts for deciduous vegetation to re-orient new growth and shape shade trees, shrubs and ornamental trees. This pre-determined “convex cut” makes the curved cuts reorient the tree limbs to a pre-desired radial shape and encourages the tree limbs to re-orient and grow. This results in the deciduous tree canopy that is round or radial in shape. The pre-determined angle cutting proves useful for either on the outside perimeter or for clearing inside the tree canopy for power lines. Essentially any pre-determined angle of clearing or directional shaping to re-orient new growth can be done with this cutting method.

### CROSS-REFERENCE TO RELATED APPLICATIONS

This application is a Continuation-in-Part [C.I.P.] filed under 37 CFR 1.53(b) and claims the benefit of the original, non-provisional (Regular Utility) U.S. patent application Ser. No. 12/859,237 submitted Aug. 18, 2010 and Published Feb. 24, 2011 as US 2011-0041396 A1. The original application was active on the date of the submission of this C.I.P. the original application and publication are entitled a “Convex Cutting and Trimming Method for Shaping Trees” and were submitted by Robert N. Stafford. The original application is incorporated fully by reference as if it were reproduced here, verbatim. This application also claims the benefit of Provisional Patent Application Ser. No. 61/235,026 filed Aug. 19, 2009 by Robert N. Stafford and entitled “Convex Cutting and Trimming Method for Shaping Trees”.

### FIELD OF INVENTION

A tree trimming method described within is related to a convex method of angular trimming of trees. The methodology uses pre-determined angle cuts to re-orient new growth for tree trimming and shaping of all shade trees, evergreen trees, and ornamental trees. The angle cutting of limbs in a “convex cut” or essentially rounding a shape like a surface of a sphere as opposed to “concave cut” or creating a hollow or depression. This makes curved cuts which direct the tree limbs (i.e. encourage them to grow) in a more natural-looking radial shape, resulting in the tree canopy to be round or radial in shape. Angle cutting proves useful either on the outside perimeter of the desired growth canopy or useful in vertical removal inside the tree canopy for clearance (for power lines, building edges, and such). Essentially any desired angle of clearing or directional shaping can be done with this of cutting method—under the canopy, on the sides, at the top, or clearing pathways through the middle without damage to the trees.

### FEDERALLY SPONSORED RESEARCH

None.

### SEQUENCE LISTING OR PROGRAM

None.

### BACKGROUND

### Field of Invention and Prior Art

A. Introduction of the Problems Addressed

For hundreds of years it has been a common and standard practice in the trimming industry to make straight cut on a basically a horizontal plane when cutting limbs and branches from trees. However, trimming in the newly conceived convex or pre-determined angular cutting method to direct and encourage growth has many advantages over the conventional accepted methods now in use:
Fact 1: Applicant Stafford, after trying different ways of trimming and shaping trees discovered and invented the proper way to trim and shape all trees: Convex trimming with pre-determined angle cutting of tree limbs whether inside or outside of trees.
Fact 2: Stafford Tree Service has developed and now performs a method to trim and shape trees unlike any method the world has never seen—Convex Pre-determined Angle Trimming. Tree limbs, shrubs, ornamental trees, horizontal and vertical growing trees are all part of the family of deciduous vegetation that benefits from the new method. These have an uneven surface that protrude in a ragged manner. The predetermined angular cutting method encourages the growth to curve outward approximately 45 degrees in angle, making the vegetation come back to its natural shape no matter how out of proportion the tree is now. Now, even with irregular growth or storm damage the tree can be brought back to its natural shape.
Fact 3: All trees heal by nature from the outside perimeter of a cut growing over the wound or cut. This convex pre-determined angle trimming limbs on trees heal manifold or heal essentially perpendicular to the plane of the cut, compared to conventional trimming or cutting. This is because conventional trimming has been done in a horizontal fashion (essentially perpendicular to gravity), thus almost always causing nearly every limb dying out and/or leaving/having a rotten place sets up in the canopy of the tree. This condition causes a cavity in the tree limb which lets water set in there and enabling further decay of the tree limbs and trunks. These conventional, simple flat cuts cannot drain off water, snow and ice and dry very well.
Fact 4: Convex pre-determined angle trimming causes little or no tree damage when done right. It enhances the tree limb growth and strength to tree trunks making them grow larger. Health to the tree is promoted. Trees are strengthened to survive wind storms and natural bad weather, outside or inside the tree.
Fact 5: Inside convex pre-determined angle trimming clears for power lines, telephone and cable lines, edges of buildings and such. One can change tree growth direction and make trees safer to homeowner.
Fact 6: Applicant of Stafford Tree Service originated this true directional tree trimming and shaping process. They have perfected this improved cutting and shaping method.

B. Prior Art

The most basic and simple methods and devices to trim trees date back several years. The historical technology focused on devices that only trimmed straight across the branches in an essentially horizontal (perpendicular to gravity) fashion. The pruning knife patent, U.S. Pat. No. 978,574, was issued 1910 to Frumviller. In this device, the branch rested in the hook of the tool and the knife sliced the branch perpendicular to the longitudinal direction of the branch. This resulted in the flat, straight cut which did nothing to help form or encourage the tree to grow in a certain direction. Another much later device is shown by a 1981 U.S. Pat. No. 4,269,241 issued to Hickman that descried a process and apparatus for severing limbs. While the device was more complex and capable of being on a motorized vehicle, the resultant cutting was still perpendicular and did not serve to direct the tree's future growth.

Another patent for a tree trimming apparatus and method was issued as U.S. Pat. No. 5,001,858 (1991) to Frazar. It taught a plant trimming apparatus comprised of a cutting device operated in conjunction with a support apparatus. The cutting device includes an elongated handle member attached to a cutter, the cutter being preferably an electrical chain saw or tree trimmer. The handle is supported by a fulcrum apparatus which provides leverage for manipulating the cutter. The fulcrum apparatus comprises a pair of hollow tubes hingedly connected together to provide a V-shaped fulcrum point in which the handle rests. A third leg of pipe is hingedly connected to one of the legs, further down from the fulcrum point, to act as a third leg of a tripod. Another lopping tool and method for lopping invented by Schofield is shown in U.S. Pat. No. 6,345,445 (2002). It is a tool for performing lopping, pruning and similar operations and it includes a tool support, a tool head, an actuating line and an actuating handle. The tool support preferably includes a pair of telescoping tubes and the tool head includes a blade movable to perform cutting operations. The blade is coupled to the actuating line and remotely movable by tensioning the actuating line. It fails to anticipate the present device.

An apparatus for trimming and chemically treating trees in U.S. Pat. No. 6,990,770 (2006) was issued to Terrell. Here the prior art taught an apparatus preferably coupled to a boom on a truck which can simultaneously trim and chemically treat trees or other vegetation with a herbicide. The apparatus, in addition to have a standard saw blade assembly with limb clamping jaws, includes a sprayer assembly. The sprayer assembly includes nozzles which administer herbicides or other chemical treatments adjacent to the saw blades, allowing herbicide to be precisely administered to the tree limbs as they are cut. It fails to anticipate the present device. It is extremely complex compared to Stafford's method. Another recent idea is taught by Jordan in a U.S. Patent Application 2004/0187462 called a pruning device for removing branches from living trees. It shows a pruning device for removing branches from living trees, comprising a cradle with drive means and pressure means for moving the pruning device along a tree trunk and with a sawing unit which has at least one branch saw which is arranged on the cradle in a fixed or displaceable manner. According to the invention, the branch saw is embodied in the form of a circular saw, on the periphery of which are arranged exclusively non-crossed saw teeth. It also fails to anticipate the present device.

Publications regarding methods to trim trees include the circular writing McConnell et al., “How to Prune Coniferous Evergreen Trees,” University of Idaho College of Agriculture, available at www.cals.uidaho.edu/edcomm/pdf/bul/buI0644.pdf (1998) (hereinafter McConnel,) and by Welsh et al., “Follow Proper Pruning Techniques,” AgriLife Extension, Texas A&M Extension, available at http://web.archive.org/web/20090405215906/ http://aggie-horticulture.tamu.edu/publications/landscape/pruning/pruning.html (5 Apr. 2009). McConnell does not expressly disclose shaping a growth of a deciduous tree or a deciduous shrub, or using a powered saw. Welsh directed to a cutting and trimming process and business method for shaping a growth of vegetation for deciduous trees and shrubs using a powered saw. However, Welsh was published well after Stafford began his diligent and continuous work to perfect his method for deciduous vegetation and the like.

The particular method used is unique and novel and is not anticipated by prior art. As far as known, there is no other angular or otherwise tree trimming methods to accomplish this convex pattern of tree trimming that promotes radial growth.

### SUMMARY OF THE INVENTION

A new Trimming Method for Shaping Trees called the “Convex Cutting” has been developed. It consists of essentially having method that provides a surface of the tree canopy which curves outward approximately 45 degrees (from essentially vertical or the pull of gravity) in a pre-determined angle, making the tree come back to its natural shape no matter how out of portion the tree is now. It may be accomplished by several machines and devices. For example and not limitation, the method can be accomplished with saws (hand or power driven), pruning shears, and non-conventional limb cutting devices. For tree services and significant cutting in the industry, a powered saw is preferred. A complete description is below with the Detailed Description.

The use of the Convex Cutting and Trimming Method to re-orient new growth for Shaping Trees provides concrete and substantial benefits to the business and economics of trimming through better labor use, energy, and repeatable success over other current trimming methods. Hence a new trimming process and business method is achieved. One skilled in financial calculations and determinations realize that when fewer hours are required to accomplish the same or a better result for a task (at the same wage scale), then a financial savings to accomplish the task is achieved.

The preferred embodiment of method or process is comprised of several steps of observation as to the tree trimming—at a pre-determined angle—needs, the characteristics of the tree and its limbs, and a precise cutting as described below.

### OBJECTS AND ADVANTAGES

There are several objects and advantages of the new Convex pre-determined angular Cutting and Trimming Method to re-orient new growth for Shaping Trees. The following TABLE A summarizes various advantages and objects of the methods. This list is exemplary and not limiting to the many advantages offered by this new method.

TABLE A
Various Benefits, Advantages and Objects This device:

| ITEM | BENEFIT |
|---|---|
| 1. | May be used on various deciduous, evergreen and |
| | ornamental trees as well as shrubs and bushes. |
| 2. | Provides better limb and branch shaping than |
| | conventional horizontal cutting of trees |
| 3. | Reduces, if not eliminates, wound seal over that |
| | results in dead, rotten or diseased tree limbs, and |
| | hence increases the limb life and resultant overall |
| | tree-life |
| 4. | Is easy to use |
| 5. | May be used to reshape a poorly trimmed |
| | conventional method |
| 6. | Is consistent |
| 7. | Reduces labor requirements for repeated removal of |
| | dead limbs resultant from the conventional |
| | horizontal cut system |
| 8. | Harmonizes tree growth with desired shape of tree |
| 9. | Improves overall business methods in trimming by |
| | significantly increasing yield and reducing costs |
| | per tree trimmed |

Noteworthy is that other advantages and additional features of the present Convex Cutting and Trimming Method to re-orient new growth for Shaping Trees method will be more apparent from the accompanying drawings and from the full description of the device. For one skilled in the art of trimming and shaping trees, it is readily understood that the features shown in the examples with these methods are readily adapted for improvement to other types of methods for use with the tree-trimming industry in general and the cutting methods in particular.

### DESCRIPTION OF THE DRAWINGS

### Figures

The accompanying drawings, which are incorporated in and constitute a part of this specification, illustrate a preferred embodiment for the Convex Cutting and Trimming Method to re-orient new growth for Shaping Trees Method. The drawings together with the summary description given above and a detailed description given below serve to explain the principles of the method for Convex Cutting and Trimming for Shaping Trees. It is understood, however, that the method is not limited to only the precise arrangements and instrumentalities shown.

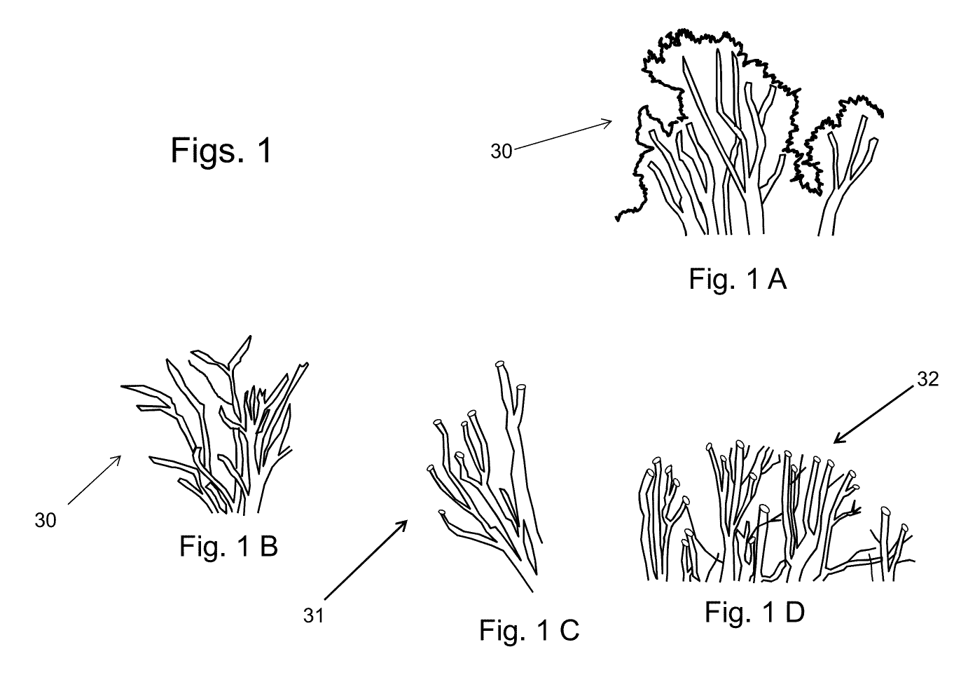

FIGS. 1 A through 1 D are sketches of the result of the trimming method and process to re-orient new growth.

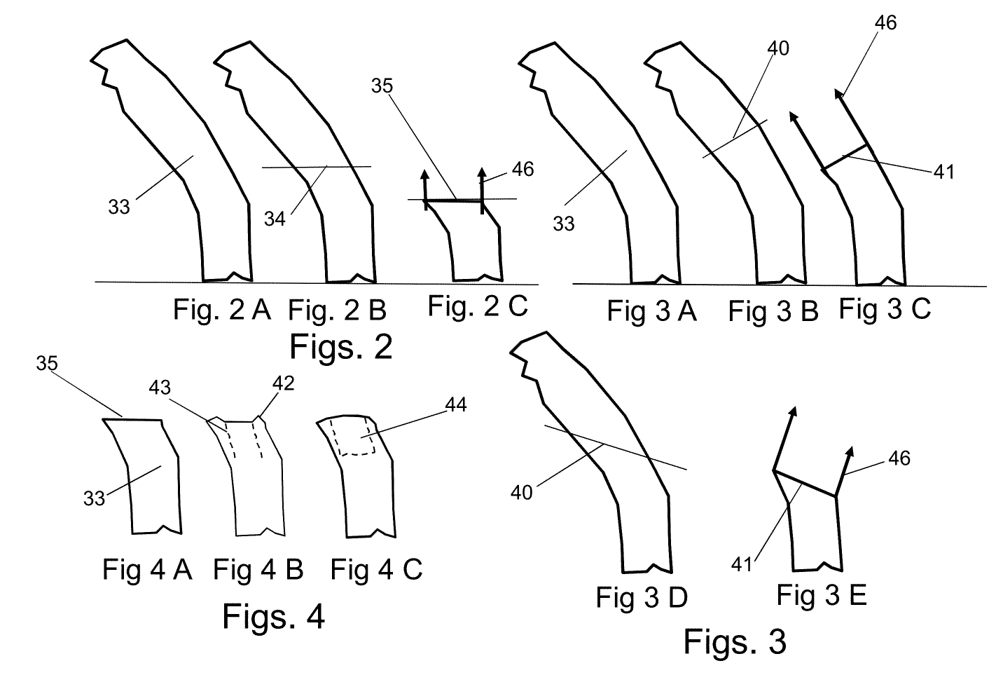

FIGS. 2 A through C are sketches of a typical copy cat horizontal cut or hack of the trim process.

FIGS. 3 A through 3 E are sketches of an improved cutting that results from the method of the angle cut method.

FIGS. 4 A through 4 C are sketches that simulate the resulting problems from a horizontal or hack copycat cut.

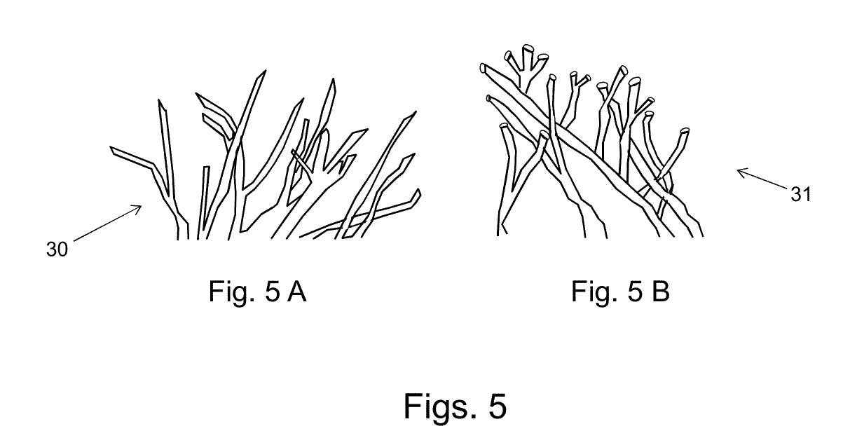

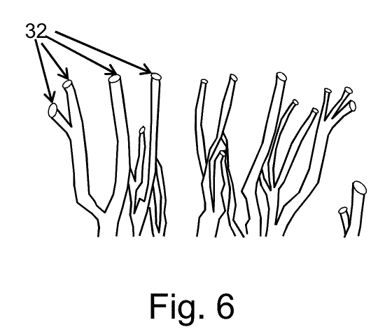

FIGS. 5 A and 5 B are additional sketches of the result of the trimming method and process.

FIG. 6 is another sketch of the result of the trimming method and process.

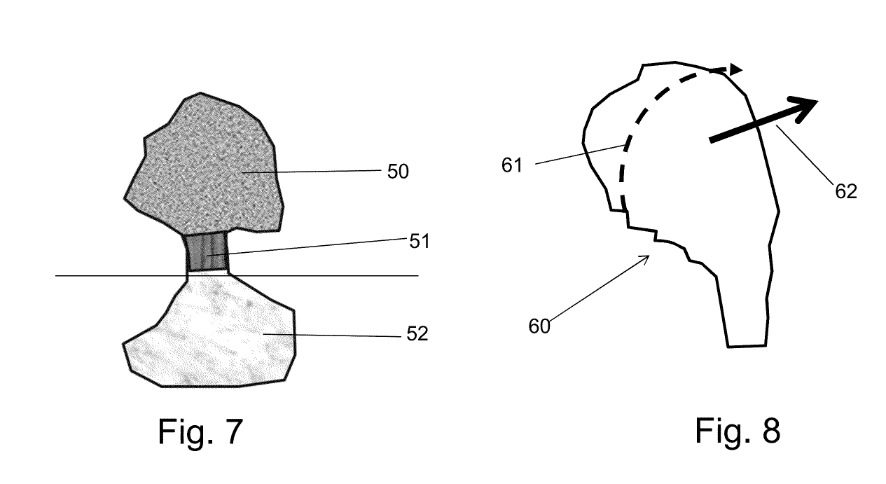

FIG. 7 is a sketch showing relationship of the canopy, tree trunk and root system.

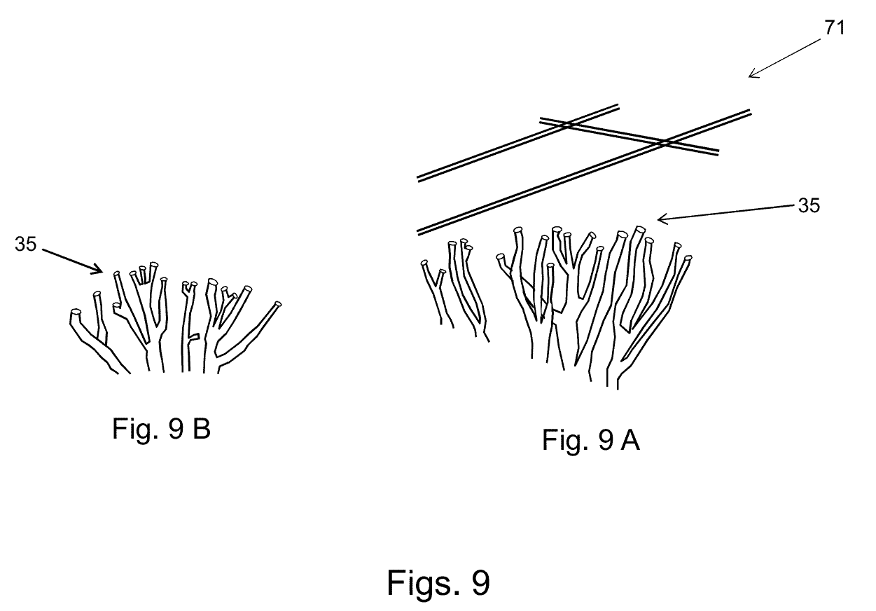

FIG. 8 is a sketch showing a lopsided tree and how the general radial cutting brings it back to a radial canopy.

FIGS. 9 A and 9 B are additional sketches of the result of a copy-cat horizontal hacking method of trimming the tree.

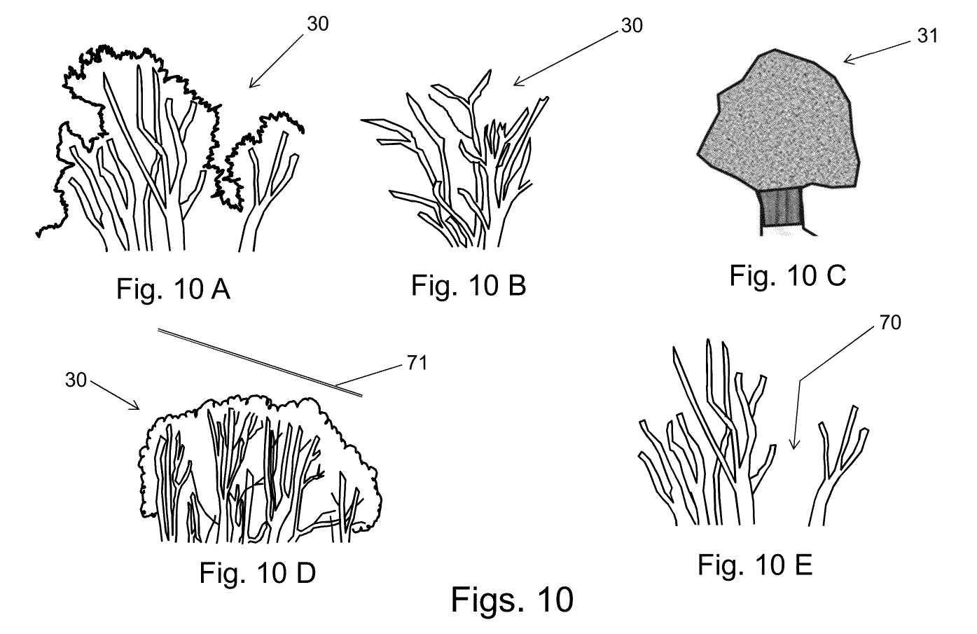

FIGS. 10 A through 10 C are sketches of the result of the trimming method and process and FIGS. 10 D and 10 E are sketches of the trimming method around power lines.

### DESCRIPTION OF THE DRAWINGS

### Reference Numerals

The following list refers to the drawings:

TABLE B
Reference numbers

| Ref # | Description |
|---|---|
| 30 | Pre-cut or un-trimmed tree |
| 31 | Typical post-cut or trimmed tree after the pre- |
| | determined, angular cut |
| 32 | Close-up of pre-determined angle cut tree limb after cut |
| 33 | Branch or limb to be cut or trimmed |
| 33A | Branch or limb after it is cut or trimmed |
| 34 | Conventional Horizontal cut (hack) line |
| 35 | Conventional Horizontal cut (hack) copy cat attempts |
| 40 | Pre-determined Line of cut angle |
| 41 | Pre-determined Angle cut to re-orient new growth |
| 42 | Overgrowth of horizontal (essentially perpendicular to |
| | gravity)cut |
| 43 | Dead or dying migration after horizontal cut (hack) |
| 44 | Dead or dying pockets or space of wood after horizontal |
| | cut (hack) |
| 46 | Growth direction - essentially perpendicular to the new |
| | cut line - i.e. re-oriented new growth line |
| 50 | Tree canopy |
| 51 | Tree trunk |
| 52 | Tree root system |
| 60 | Side growth of tree - “lopsided” |
| 61 | Direction for radial growth - in a pre-determined |
| | reoriented direction |
| 62 | General direction for lopsided/side growth |
| 70 | Interior limbs/growth cleared for Power line |
| 71 | Power line |
| 80 | Convex Cutting and Trimming Method for Shaping Trees |

### DETAILED DESCRIPTION OF PREFERRED EMBODIMENT

The method and process invention presented is Convex Cutting and Trimming Method to re-orient new growth for Shaping Trees. This method to a new method to increase tree survival by controlling radial growth patterns of trimmed trees. Improvements from labor, loss of trees due to poor trimming, and other savings in fuel due to less frequent trimming yield concrete financial gains in this method of doing trimming compared to typical horizontal trimming processes.

The preferred embodiment of Convex Cutting and Trimming Method for Shaping Trees 80 is comprised of several steps of observation as to the tree trimming needs, the characteristics of the tree and its limbs, and a precise cutting as described. A convex cutting and trimming method for shaping a growth of a deciduous vegetation comprised of the following steps:

| | |
|---|---|
| a | STEP 1: Observing an existing shape and a radial, |
| | natural growth of the vegetation; |
| b | STEP 2: Predetermining a desired shape of a canopy for |
| | the vegetation; |
| c | STEP 3: Pre-determining if there is an obstructions |
| | for future vegetation growth; |
| d | STEP 4: If there is an obstruction, cutting the |
| | vegetation with a pre-determined angular cut at an |
| | essentially 45 degree angle to the pull of gravity to |
| | provide a clearance space for the obstruction; |
| e | STEP 5: Viewing a group of the remaining limbs and |
| | branches of the canopy; |
| f | STEP 6: Determine the direction of natural, radial |
| | growth of the group; |
| g | STEP 7: Deciding a direction of desired growth which |
| | will be perpendicular to a cut plane; |
| h | STEP 8: Cutting the limbs at an essentially 45 degree |
| | angle to gravitational pull(i.e. vertical) with a |
| | means for cutting; and |
| i | STEP 9: Repeating Steps 1 through 8 as necessary. |

wherein a special method may be used to trim and cut trees to a desired shape and may significantly reduce a cost of trimming. This method to re-orient new growth results in having a surface that curves outward (in many cases) essentially 45 degrees in angle to horizon (ie essentially perpendicular to gravity), making or encouraging the tree to come and to grow in a pre-determined direction and back to its natural shape no matter how out of portion the tree is now. The types of vegetation (for example and not limitation) growth may be bushes, shrubs, deciduous trees evergreen/non-deciduous and ornamental trees. The means for cutting may be a hand or powered saw, a pruning device, a loping device, or other device for cutting vegetation. The preferred means is a powered saw.

There is shown in FIGS. 1-10 a complete detail of the results from the Convex Cutting and Trimming Method to re-orient new growth for Shaping Trees 80. In the drawings and illustrations, one notes well that the FIGS. 1 through 10 describe more of the results from using the Convex Cutting and Trimming Method to re-orient new growth for Shaping Trees

The advantages and benefits for the Convex Cutting and Trimming Method for Shaping Trees are:
May be used on various deciduous, evergreen and ornamental trees as well as shrubs and bushes.
Provides better limb and branch shaping than conventional horizontal cutting of trees
Reduces if not eliminates wound seal over that results in dead, rotten or diseased tree limbs, and hence increases the limb life and resultant overall tree-life*
Is easy to use
May be used to reshape a poorly trimmed conventional method
Is consistent
Reduces labor requirements for repeated removal of dead limbs resultant from the conventional horizontal cut system*
Harmonizes tree growth with desired shape of tree
Improves overall business methods in trimming by significantly increasing yield and reducing costs per tree trimmed

* One skilled in the art of the tree trimming business may well appreciate that the reduced labor and the elimination or reduction of dead, rotten or diseased tree limbs increases the limb life and resultant overall tree-life. Therefore the immediate cost of performing the trimming has an improved cost. Likewise the overall lifetime cost of not replacing a tree early due to poor limb trimming will in effect reduce the cost of having the tree. This especially holds important for commercial settings around malls, parking areas and parks where a “green” effort requires so much vegetation for a given area of pavement or building improvements.

FIGS. 1 A through 1 D are sketches of the beginning condition and results of the trimming method and process 80. FIGS. 1 A and 1 B are tree canopies prior to cut 30. FIG. 1 C is a canopy after cut/trim 32 using the Convex Cutting and Trimming Method to re-orient new growth for Shaping Trees 80. FIG. 1 D is a close-up of the angle cut 32.

FIGS. 2 A through C are sketches of a typical copy-cat horizontal (essentially perpendicular to gravity) cut or hack of the trim process 35. FIG. 2 A is the branch 33. FIG. 2 B shows the cut line 34. FIG. 2 C shows the cut 35 and the encouraged and natural growth direction—essentially perpendicular to cut line 46.

FIGS. 3 A through 3 E are sketches of an improved cutting that results from the method of the pre-determined angle cut method 80. They show the branch 33, the cut lines 40, the cut 41, and the growth direction—essentially perpendicular to cut line 46. This predetermined angle cut is in contrast to the flat, horizontal conventional cut shown in FIG. 2 C.

FIGS. 4 A through 4 C are sketches that simulate the resulting problems from a conventional, horizontal or hack copy-cat cut 35. FIG. 4 A is the branch after the cut 33A. FIG. 4 B is after the cut 33A with the overgrowth of horizontal cut 42 and the dead or dying migration after horizontal cut (hack) 43. FIG. 4 C is the branch after the cut 33A with the dead or diseased wood 44 in the heart of the cut branch or limb 33 A.

FIGS. 5 A and 5 B are sketches of the results of the pre-determined trimming method and process. FIG. 5 A is the original tree canopy 30. FIG. 5 B is a sketch after the pre-determined cut 31.

FIG. 6 is a post cut sketch of the Convex pre-determined angle Cutting and Trimming Method to re-orient new growth for Shaping Trees 31.

FIG. 7 is a sketch showing relationship of the canopy, tree trunk and root system. The canopy 50, the tree trunk 51 and the root system 52 are shown. One skilled in tree growth well appreciates that a healthy canopy 51 mirrors a healthy root system 52

FIG. 8 is a sketch showing a lopsided tree 60 and how the general radial cutting brings it back to a radial canopy. The direction for radial growth 61 is shown with the general direction for the lopsided/side growth 62 to regain the proper canopy.

FIGS. 9 A and 9 B are sketches of the result of a copy-cat horizontal hacking method of trimming the tree 35.

FIGS. 10 A through 10 C are sketches of the result of the trimming method and process 80. FIGS. 10 A and 10 B are the original tree canopies 30. FIG. 10 C is a sketch of the tree 31 after the pre-determined cut 32. FIGS. 10 D and 10 E are sketches of the trimming method around power lines 71.

All of the details for the Convex Cutting and Trimming Method to re-orient new growth for Shaping Trees mentioned here are exemplary and not limiting. It is anticipated that other steps and observations may be added as a person having ordinary skill in the field of the tree trimming industry and related equipment and methods well appreciates.

### Operation of the Preferred Embodiment

The process of Convex Cutting and Trimming Method to re-orient new growth for Shaping Trees and results are discussed above. More of the operation is discussed further below.

FIGS. 2 A through C are sketches of a typical copy cat horizontal cut or hack of the trim process 35. FIGS. 3 A through 3 E are sketches of an improved cutting that results from the method of the convex angle cut method 80.

FIG. 7 is a sketch showing relationship of the canopy 50, tree trunk 51 and root system 52.

FIG. 8 is a sketch showing a lopsided tree 60 and how the general radial cutting 61 brings it back to a radial canopy.

With the above description it is to be understood that Convex Cutting and Trimming Method for Shaping Trees is not to be limited to only the disclosed embodiments. The features of methods and devices are intended to cover various modifications and equivalent arrangements included within the spirit and scope of the descriptions.

1. A convex cutting and trimming method for shaping a growth of a deciduous vegetation comprised of the following steps:
a STEP 1: Observing an existing shape and a radial, natural growth of the vegetation;
b STEP 2: Pre-determining a desired shape of a canopy for the vegetation;
c STEP 3: Pre-determining if there is an obstructions for future vegetation growth;
d STEP 4: If there is an obstruction, cutting the vegetation with a pre-determined angular cut at an essentially 45 degree angle to the pull of gravity to provide a clearance space for the obstruction;
e STEP 5: Viewing a group of the remaining limbs and branches of the canopy;
f STEP 6: Determine the direction of natural, radial growth of the group;
g STEP 7: Deciding a direction of desired growth which will be perpendicular to a cut plane;
h STEP 8: Cutting the limbs at an essentially 45 degree angle to gravitational pull (i.e. vertical) with a means for cutting; and
i STEP 9: Repeating Steps 1 through 8 as necessary. wherein a special method may be used to trim and cut trees to a desired shape and may significantly reduce a cost of trimming.

2. The method according to claim 1 wherein a type of vegetation growth is a deciduous tree.

3. The method according to claim 1 wherein a type of vegetation growth is a deciduous shrub.

4. The method according to claim 1 wherein a means to cut is a loping device.

5. The method according to claim 1 wherein a means to cut is a powered device.

6. The method according to claim 5 wherein the powered device is a powered saw.

7. A convex cutting and trimming method for shaping a growth of a deciduous vegetation comprised of the following steps:
a STEP 1: Observing an existing shape and a radial, natural growth of the vegetation;
b STEP 2: Pre-determining a desired shape of a canopy for the vegetation;
c STEP 3: Viewing a group of the remaining limbs and branches of the canopy;
d STEP 4: Determine the direction of natural, radial growth of the group;
e STEP 5: Deciding a direction of desired growth which will be perpendicular to a cut plane;
f STEP 6: Cutting the limbs at an essentially 45 degree angle to gravitational pull (i.e. vertical) with a means for cutting; and
g STEP 7: Repeating Steps 1 through 8 as necessary. wherein a special method may be used to trim and cut trees to a desired shape and may significantly reduce a cost of trimming.

8. The method according to claim 7 wherein a type of vegetation growth is a deciduous tree.

9. The method according to claim 7 wherein a type of vegetation growth is a deciduous shrub.

10. The method according to claim 7 wherein a means to cut is a loping device.

11. The method according to claim 7 wherein a means to cut is a powered device.

12. The method according to claim 11 wherein the powered device is a powered saw.
